(19) United States
(12) Patent Application Publication
(10) Pub. No.: US 2012/0031551 A1
(43) Pub. Date: Feb. 9, 2012

(54) METHOD FOR TRANSFER PRINTING NANOWIRES

(75) Inventor: Chia-Ling Hsu, Tu-Cheng (TW)

(73) Assignee: HON HAI PRECISION INDUSTRY CO., LTD., Tu-Cheng (TW)

(21) Appl. No.: 12/869,773

(22) Filed: Aug. 27, 2010

(30) Foreign Application Priority Data
Aug. 5, 2010 (TW) 99126021

(51) Int. Cl. B32B 38/10

(52) U.S. Cl. 156/247

(57) ABSTRACT

A method for transfer printing nanowires, includes the following steps. First, a first substrate having nanowires formed thereon, is provided. Second, a transfer printing film is provided. The transfer printing film is hydrophobic and is in a soft state. Third, the transfer printing film and the first substrate are combined with the nanowire array in contact with the transfer printing film. Fourth, a roller is applied on the transfer printing film to press the transfer printing film against the first substrate. Fifth, the first substrate is removed, thereby obtaining the nanowires transfer printed on the transfer printing film with the nanowires reoriented along a substantially same direction.

### BACKGROUND

1. Technical Field

The present disclosure relates to nanowires, and particularly to a method for transfer printing nanowires.

2. Description of Related Art

Nanowires have a variety of applications such as in sensors and in transistors, because the nanowires show excellent mechanical characteristics, quantum effects, and high surface to volume ratios.

Nanowires are usually grown on a substrate. Due to the size of nanowires, it is difficult to allow the nanowires to arrange substantially along a same direction after being collected from the substrate or being transferred from one substrate to another substrate.

Dielectrophoresis, micro-fluid channel and blown film extrusion methods have been used to collect or transfer the nanowires. However, these methods each take a substantial amount of time.

What is needed, therefore, is a method for transfer printing nanowires which can overcome the above shortcomings.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a perspective view of a transfer printing film and a first substrate having nanowires grown thereon in accordance with an exemplary embodiment.

FIG. 2 shows a roller apparatus to roll on the combined transfer printing film and the first substrate shown in FIG. 1.

FIG. 3 is a scanning picture showing the nanowires push over on the first substrate of FIG. 1.

FIG. 4 shows the transfer printing film of FIG. 1 has the nanowires transfer printed thereon.

FIG. 5 is a scanning picture showing the nanowires on the transfer printing film of FIG. 4.

FIG. 6 shows a second substrate has the nanowires transfer printed thereon from the transfer printing film of FIG. 4.

FIG. 7 is a scanning picture showing the nanowires on the second substrate.

### DETAILED DESCRIPTION

Embodiments of the present method will now be described in detail below and with reference to the drawings.

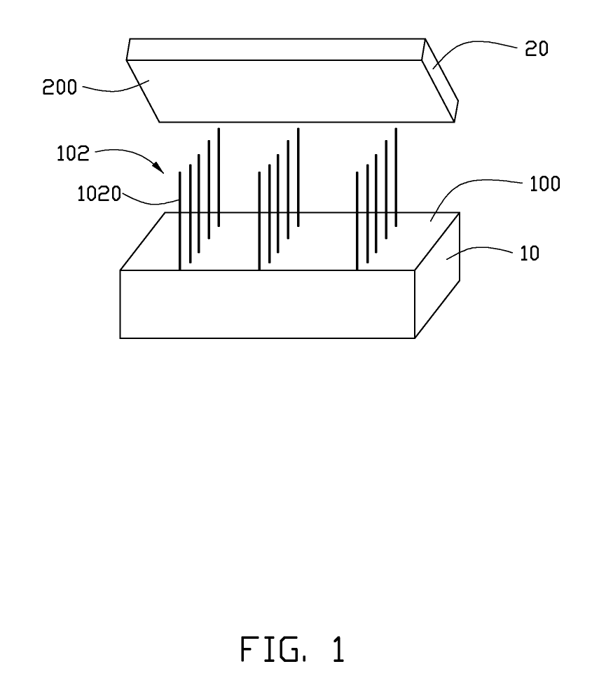

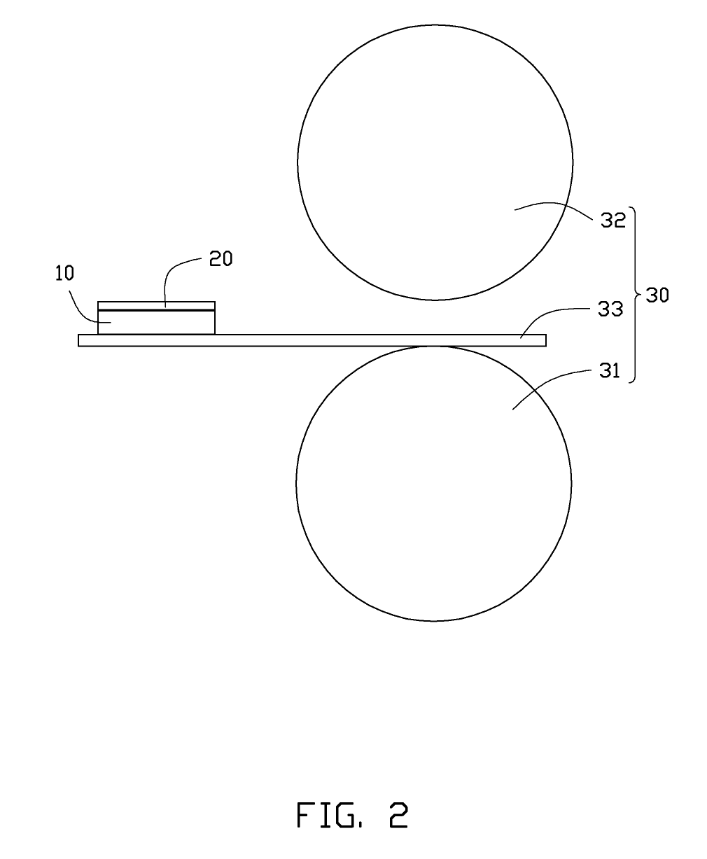

Referring to FIGS. 1 and 2, an exemplary method for transfer printing nanowires, includes the following steps.

First, a first substrate 10 having nanowires 1020 formed on a surface 100 thereof, is provided. The first substrate 10 is Si-based, i.e., the first substrate 10 contains Si element. The first substrate 10 can be made fully by Si. The nanowires 1020 are in a nanowire array 102. The nanowires 1020 can be Si-based, or are polymer.

Second, a transfer printing film 20 is provided. The transfer printing film 20 is hydrophobic and at a soft state during the transfer printing. In the present embodiment, the transfer printing is carried out at room temperature about 25° C., and no heating is needed for softening the transfer printing film 20. The transfer printing film 20 can be made of a polymer material which has a glass transition temperature below the room temperature, such as polydimethylsiloxane (PDMS), and polybutylacrylate (PBA).

The first substrate 10 is Si-based, the transfer printing film 20 is preferably made of PDMS. The PDMS has a molecular formula (CH₃)₃SiO[Si(CH₃)₂O]nSi(CH₃)₃, thus the PDMS is also Si-based, and thus the transfer printing 20 and the first substrate 10 and also the other Si-based substrates have an adhesive property for each other. Also, the PDMS has a hydrophobic characteristic and a low surface energy, thus once the nanowires 1020 are printed on the transfer printing film 20, the nanowires 1020 can also be taken off the transfer printing film 20 and adhered to other substrates. The transfer printing film 20 is soft, thus preventing for the most extent the nanowires 1020 from being broken into pieces during the transfer printing.

Then, the transfer printing film 20 is combined with the first substrate 10 with the nanowires 1020 in contact with a surface 200 of the transfer printing film 20.

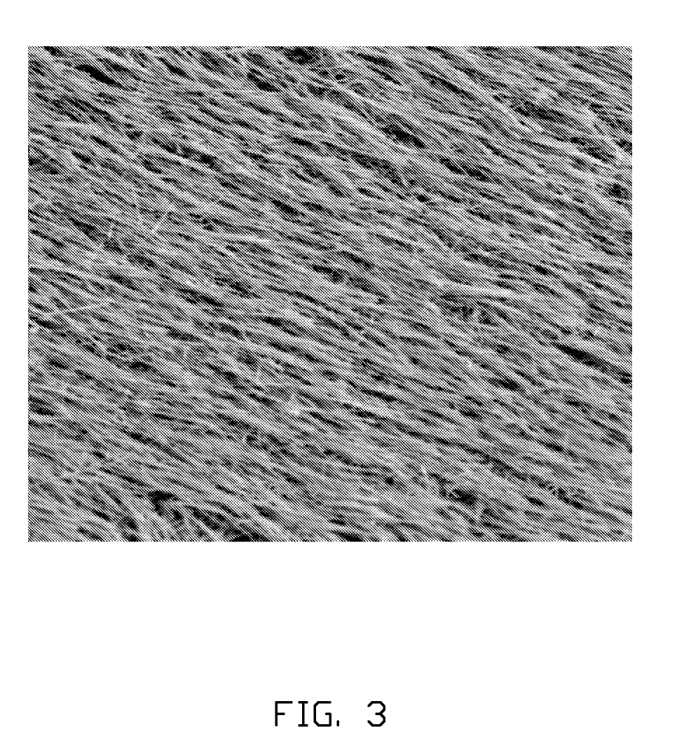

Next, a roller apparatus 30 is provided. The roller apparatus 30 includes a first roller 31, second roller 32 and a delivering belt 33. The combined first substrate 10 and transfer printing film 20 are disposed on the delivering belt 33. The first roller 31 rolls under the delivering belt 33. The second roller 32 rolls on the transfer printing film 20 at the opposite surface of the surface 200 along a straight line direction, thus ensures that nanowires 1020 are push over along a same direction on the first substrate 10 (see FIG. 3).

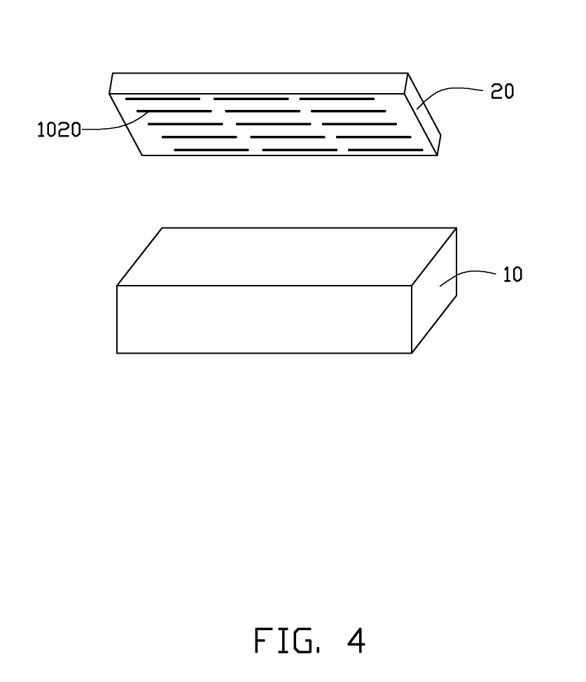

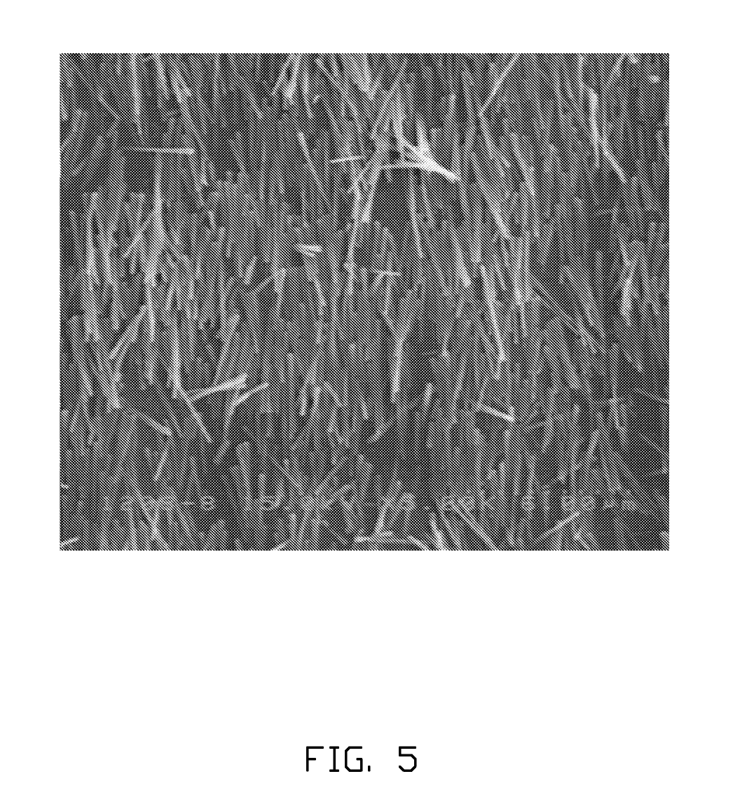

Referring to FIG. 4, at a same time the nanowires 1020 are push over, the first substrate 10 and the transfer printing film 20 are compressed, thus the nanowires 1020 can be adhered to the transfer printing film 20. Then the first substrate 10 can be removed. That is, the nanowires 1020 are transfer printed on the transfer printing film 20 with the nanowires 1020 substantially reoriented along the same direction on the transfer printing film 20 (see FIG. 5).

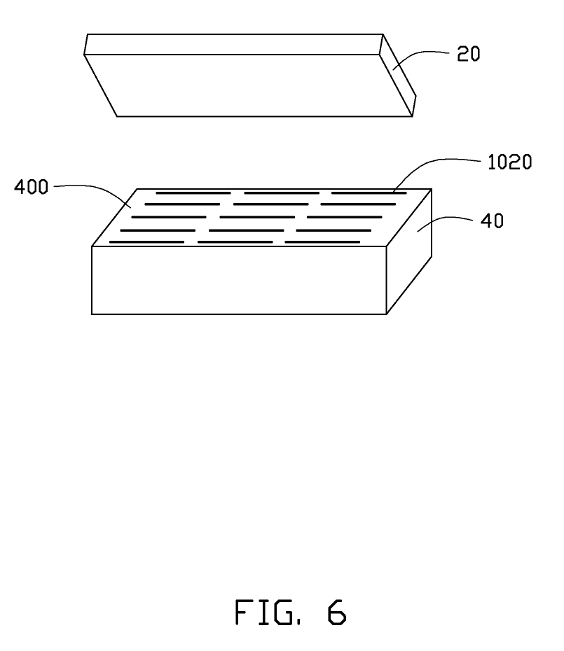

Referring to FIG. 6, in a next transfer printing process, a second substrate 40 is first provided. The second substrate 40 can be made of Si, SiO₂ or a polymer material. Then the second substrate 40 is applied to the transfer printing film 20 to allow the nanowires 1020 to make contact with a surface 400 of the second substrate 40. Next, after a similar rolling step on the transfer printing film 20, the second substrate 40 and the transfer printing film 20 are compressed. Due to the transfer printing film 20 having the hydrophobic characteristic and the low surface energy, after the transfer printing film 20 is separated from the second substrate 40, the nanowires 1020 can be transfer printed on the second substrate 40.

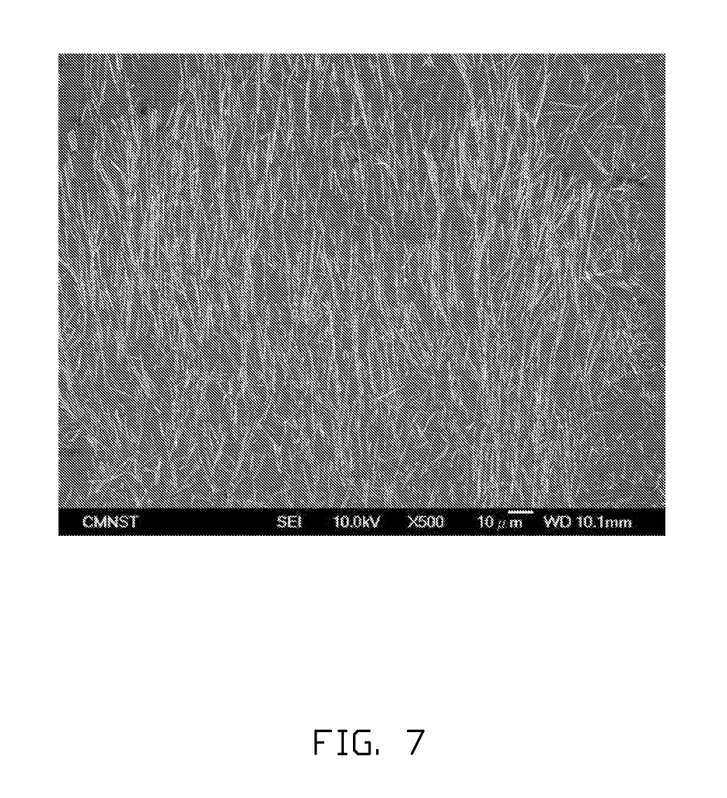

Referring to FIG. 7, the nanowires 1020 on the second substrate 40 still lie substantially along the same direction.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A method for transfer printing nanowires, comprising:
providing a first substrate having a nanowire array formed thereon;
providing a transfer printing film, the transfer printing film being hydrophobic and in a soft state;
combining the transfer printing film and the first substrate with the nanowire array in contact with the transfer printing film;
pressing the transfer printing film against the first substrate by rolling a roller on the transfer printing film; and
removing the first substrate thereby the nanowires being attached on the transfer printing film and reoriented along a substantially same direction.

2. The method of claim 1, wherein the step of pressing the transfer printing film against the first substrate is carried out at room temperature.

3. The method of claim 2, wherein the transfer printing film is made of a polymer material, and a glass transition temperature of the polymer material is below the room temperature.

4. The method of claim 3, wherein the transfer printing film is made of polydimethylsiloxane.

5. The method of claim 4, wherein the first substrate is made of Si.

6. The method of claim 1, wherein the roller moves on the transfer printing film along a straight line direction.

7. The method of claim 1, wherein the roller is provided by a roller apparatus comprising a delivering belt to carry and deliver the combined first substrate and transfer printing film, the roller rolling on the transfer printing film and another roller rolling under the delivering belt.

8. The method of claim 1, further comprising:
providing a second substrate;
combining the second substrate and the transfer printing film to bring the nanowires into contact with a surface of the second substrate;
compressing the second substrate and the transfer printing film using the roller; and
removing the transfer printing film from the second substrate and obtaining the nanowires being transferred on the surface of the second substrate.

9. The method of claim 8, wherein the step of pressing the second substrate against the transfer printing film is carried out at room temperature.

10. The method of claim 9, wherein the transfer printing film is made of a polymer material, and a glass transition temperature of the polymer material is below room temperature.

11. The method of claim 10, wherein the transfer printing film is made of polydimethylsiloxane.

12. The method of claim 11, wherein the first substrate is made of Si, and the second substrate is made of Si or SiO₂.

13. The method of claim 8, wherein the first substrate is made of Si, the transfer printing film is made of a first polymer material, and the second substrate is made of a second polymer material.

14. The method of claim 8, wherein the roller moves on the transfer printing film along a straight line direction.
